(19) United States
(12) Patent Application Publication
(10) Pub. No.: US 2014/0106185 A1
(43) Pub. Date: Apr. 17, 2014

(54) RECHARGEABLE BATTERY RECYCLING

(71) Applicant: Empire Technology Development, LLC, Wilmington, DE (US)

(72) Inventor: Ezekiel Kruglick, Poway, CA (US)

(21) Appl. No.: 13/996,537

(22) PCT Filed: Oct. 16, 2012
(86) PCT No.: PCT/US2012/060396

§ 371 Date: Jun. 20, 2013

(51) Int. Cl. G06F 17/30; H01M 10/54

(52) U.S. Cl. CPC G06F 17/30345; H01M 10/54
USPC 429/49; 707/609

(57) ABSTRACT

Technologies for recycling rechargeable batteries are described. For example, a rechargeable battery may be recycled through a cycle that includes one or more of determining a battery condition while the rechargeable battery may be used in a networkable device, updating a rechargeable battery database with the battery condition over a network, determining recycling instructions, and outputting the recycling instructions on the networkable device. In other examples, multiple rechargeable batteries may be recycled by receiving battery conditions and identification codes over a network, updating a rechargeable battery database with battery conditions and identification codes, and assigning rechargeable batteries to recycling processes according to battery conditions and identification codes.

### BACKGROUND

Unless otherwise indicated herein, the materials described in this section are not prior art to the claims in this application and are not admitted to be prior art by inclusion in this section.

Rechargeable batteries may be recycled by a variety of ways. Batteries in excellent or good condition may be redeployed or resold to consumers. Batteries in fair condition may still have value for industrial purposes, for example, for combined use in industrial power leveling units. Heavily used batteries in poor or nonfunctional condition may have no better use than dismantlement for materials recycling. Today, many recycled batteries may be sent automatically to dismantlement for materials recycling, the lowest value use. Testing may be too expensive or time consuming to perform manually for every battery at the point of recycling and may remove significant value from the recycling chain.

The present disclosure appreciates that appropriately determining recycling paths for rechargeable batteries may be a complex undertaking.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes technologies for recycling rechargeable batteries, including methods, systems, and computer readable storage media.

In various examples, methods of recycling a rechargeable battery are provided. The example methods may include determining a battery condition of a rechargeable battery while the rechargeable battery may be used in a networkable device, updating a rechargeable battery database with the battery condition over a network connection, and determining recycling instructions corresponding to the battery condition. The methods may additionally include directing the recycling instructions to a data output interface of the networkable device.

In some examples, methods of managing recycling for a plurality of rechargeable batteries are provided. The example methods may include receiving a battery condition for each of a plurality of rechargeable batteries over a network connection, receiving a corresponding identification code for each of the plurality of rechargeable batteries over the network connection, and updating a rechargeable battery database with each battery condition and each corresponding identification code. The example methods may additionally include assigning each of the plurality of rechargeable batteries to at least one of a plurality of recycling processes according to each corresponding battery condition and each corresponding identification code.

In several examples, systems for recycling a rechargeable battery are provided. The example systems may include a coupling circuit configured to be operatively coupled to a rechargeable battery; a network connection; and a controller configured to be operatively coupled via the coupling circuit to the rechargeable battery. The controller may be configured via executable instructions to receive an instruction to determine a battery condition of the rechargeable battery. Executable instructions may be included to determine the battery condition of the rechargeable battery, to update a rechargeable battery database with the battery condition over the network connection, and to select recycling instructions corresponding to the battery condition. Executable instructions may additionally be included to direct the recycling instructions to a data output interface.

In various examples, systems for managing recycling for a plurality of rechargeable batteries are provided. The example systems may include a server and a network. The server may be configured to host a rechargeable battery database. The network may be operatively coupled to the server and may be configured to facilitate communication between the server and a plurality of networkable devices. Each of the plurality of networkable devices may be configured to receive one or more of a plurality of rechargeable batteries. The server may be further configured via computer executable instructions to receive a battery condition for each of the plurality of rechargeable batteries over the network. The server may also include computer executable instructions to receive a corresponding identification code for each of the plurality of rechargeable batteries over the network, to update the rechargeable battery database with each battery condition and each corresponding identification code, and to assign each of the plurality of rechargeable batteries to at least one of a plurality of recycling processes according to each corresponding battery condition and each corresponding identification code.

In some examples, computer-readable storage media having instructions stored thereon for recycling a rechargeable battery are provided. Instructions may be included to control a processor and a status circuit operatively coupled to a rechargeable battery to determine a battery condition of the rechargeable battery, to determine an identification code for the rechargeable battery, to update a rechargeable battery database with the battery condition and the identification code over a network connection, and to select recycling instructions corresponding to the battery condition. Instructions may also be included to direct the recycling instructions to a data output interface.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1 is a conceptual plot that represents various charging and discharging behaviors and measurements in a rechargeable battery.

FIG. 2 is a conceptual drawing that represents various examples of methods and devices for rechargeable battery recycling, arranged in accordance with at least some embodiments described herein.

FIG. 3 is a conceptual drawing that represents various examples of a rechargeable battery recycling system, arranged in accordance with at least some embodiments described herein.

FIG. 4 is a block diagram that represents various examples of rechargeable battery recycling hardware and network, arranged in accordance with at least some embodiments described herein.

FIG. 5A is a flow diagram showing example blocks that may be used in various example methods of rechargeable battery recycling, arranged in accordance with at least some embodiments described herein.

FIG. 5B is a flow diagram showing further example blocks that may be used in various example methods of rechargeable battery recycling, arranged in accordance with at least some embodiments described herein.

FIG. 6 is a block diagram that represents various general purpose computing devices that may be used to implement the methods for recycling rechargeable batteries, arranged in accordance with at least some embodiments described herein.

FIG. 7 is a block diagram that illustrates various example computer program products that may be used for rechargeable battery recycling, all arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn to methods, systems, devices, and/or computer program products related to recycling rechargeable batteries.

Briefly stated, technologies for recycling rechargeable batteries are described. For example, a rechargeable battery may be recycled through a cycle that includes one or more of determining a battery condition while the rechargeable battery may be used in a networkable device, updating a rechargeable battery database with the battery condition over a network, determining recycling instructions, and outputting the recycling instructions on the networkable device. In other examples, multiple rechargeable batteries may be recycled by receiving battery conditions and identification codes over a network, updating a rechargeable battery database with battery conditions and identification codes, and assigning rechargeable batteries to recycling processes according to battery conditions and identification codes.

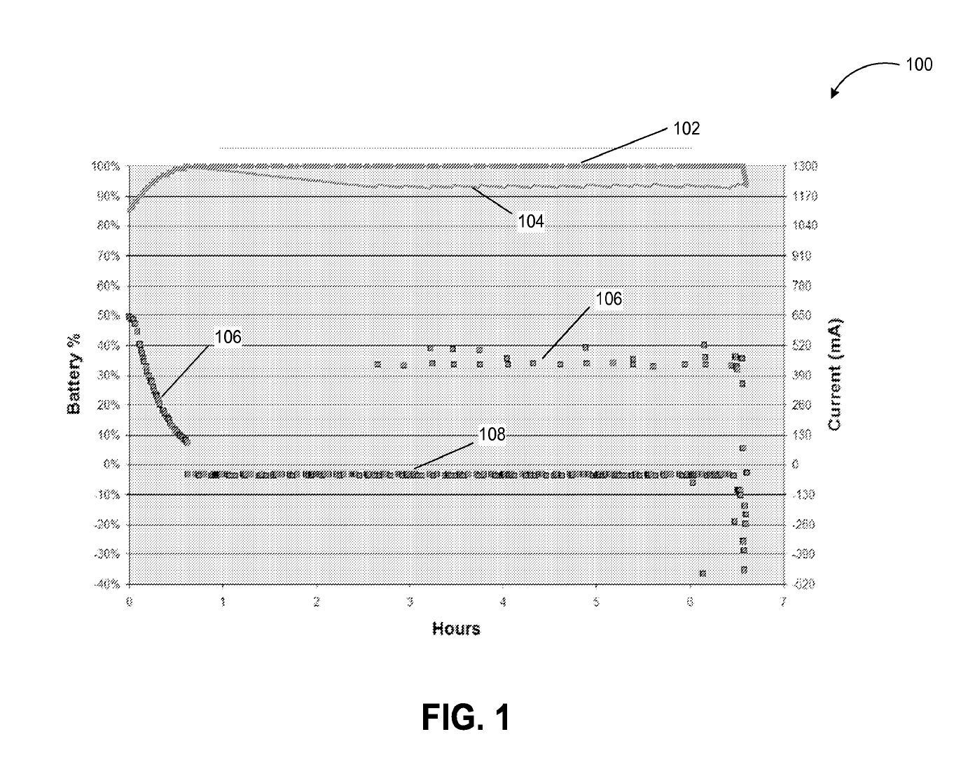

FIG. 1 is a conceptual plot 100 that represents various charging and discharging behaviors and measurements in a rechargeable battery. Plot 100 shows battery percent charge on the left vertical axis and battery charge/discharge current on the right vertical axis. Displayed battery charge 102 represents the battery level in percent charge reported by a user interface of the device, which may be inaccurate. Calculated battery charge 104 represents the battery percent charge calculated using charging current 106 into the battery and discharging current 108 out of the battery. The charging current 106 data indicates charging of the rechargeable battery in the first 30 minutes, with the charging current 106 decreasing as the battery nears a full charge. At full charge, the charging current may be shut off for a period of time between about 30 minutes and about 2 hours and 30 minutes. Between two and three hours, after the calculated battery charge 104 has decreased, the charging current 106 may be applied again periodically to maintain the battery charge 104.

Modern Li-ion batteries do not suffer the memory effect of older technologies that would require occasional full discharges to stay healthy. One drawback they do still have, however, is that holding a Li-ion battery of any type at full charge state is yet another way to reduce its cycle life substantially versus letting it stay at 85%-90% of full charge. For this reason, modern battery powered portable devices and chargers may perform complicated cycling operations when charging a battery. They may charge fully initially, then switch back to battery power and allow the battery to run down to about 85%-90% of full charge and maintain the charge at this level indefinitely to keep the battery from wearing out while the device is on a docking station or charger for a long period of time. This cycling approach may be used, according to some examples, to collect data that can be used for battery voltage oscillometry.

The periodic alternating charging current 106 and discharging current 108 phase may provide suitable data useful for battery voltage oscillometry or other battery condition estimation algorithms. The battery voltage oscillometry or other battery condition estimation algorithms may be employed, but are time consuming In the example in FIG. 1, the time to charge the battery and then discharge sufficiently to enter the periodic alternating charging current 106 and discharging current 108 phase may be nearly three hours alone, not to mention time to determine battery condition during the periodic alternating charging current 106 and discharging current 108 phase. Determining battery condition manually at the time of battery recycling may take considerable time, which may not be as practical or economical as may be desired.

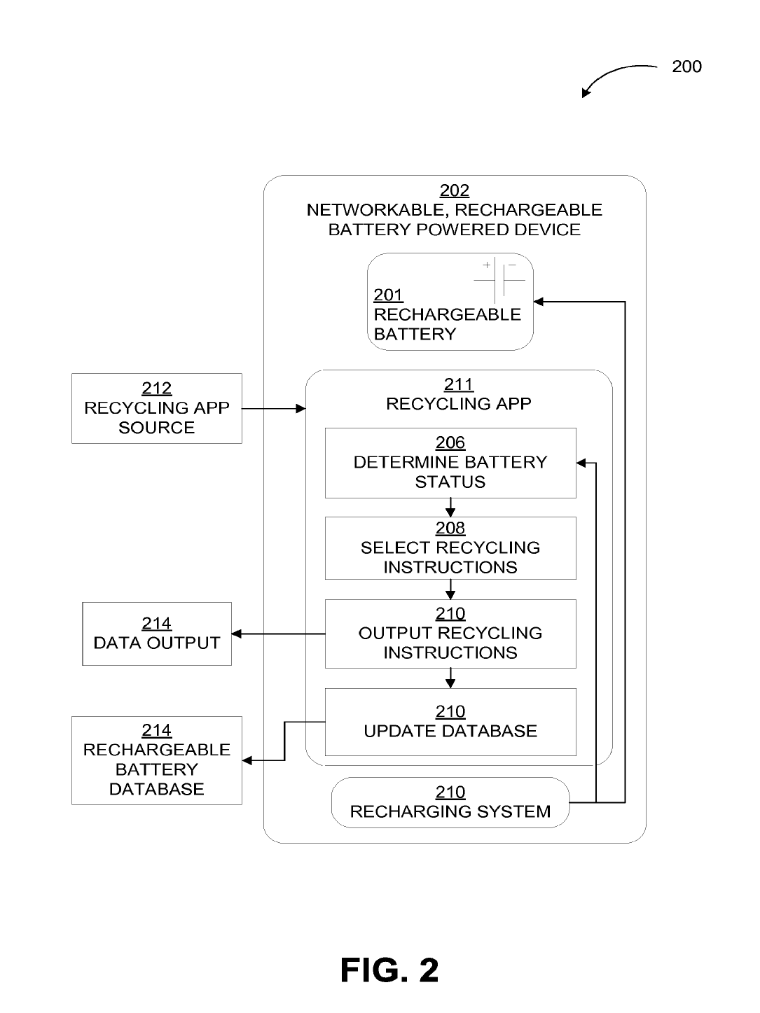

FIG. 2 is a conceptual drawing that represents various examples of methods and devices for rechargeable battery recycling, arranged in accordance with at least some embodiments described herein. FIG. 2 depicts a networkable device 202, for example, a smart phone, which may be powered by a rechargeable battery 201. The networkable device 202 may include a recharging system 210. The networkable device 202 may be configured with a recycling application 211. The recycling application 211 may include an operation 206 for determining a battery condition of the rechargeable battery 201. Based on the battery condition, the recycling application 211 may select recycling instructions in operation 208. The recycling application 211 may output recycling instructions in operation 210, for example, by displaying graphics or text on a screen of networkable device 202. The recycling application 211 may update a rechargeable battery database 214 over a network with the battery condition and optionally an identification code. The recycling application 211 may be obtained or updated from a recycling application source 212, for example, over the network.

In various examples, the networkable device 202 may be, for example, a portable networkable electronics device. Specific examples may include, but are not limited to, a cell phone, a smart phone, a tablet computer, a laptop computer, a portable media player, a portable Global Positioning System (GPS) device, a portable two-way radio, a cordless tool, a cordless appliance, and/or a battery charger. The network connection may include a passive or active interface which may be electronic, optical, radio frequency or a combination. For example, the network connection may be an Ethernet connection, a fiber optic connection, a wireless, and/or a cellular phone connection.

In some examples, the recycling application 211 may determine the battery condition of the rechargeable battery 201 while the rechargeable battery 201 may be used in the networkable device 202. For example, the battery condition may be determined periodically throughout the service life of the rechargeable battery 201 in the networkable device 202. Automatically determining the battery condition while the rechargeable battery 201 may be used in the networkable device 202 may be less burdensome on time and attention compared to manually determining battery condition at a recycling facility. Further, the battery condition may be determined while the rechargeable battery 201 may be in the custody of an end consumer. The end consumer may be motivated by the recycling instructions to change usage patterns of the networkable device 202 which may promote better battery life, facilitate recycling, or the like.

In several examples, the recycling application 211 may determine the battery condition based on one or more of a charging rate, a discharging rate, a charging cycle, a discharging cycle, a charge depth, a discharge depth, and/or a battery temperature. The recycling application 211 may determine the battery condition by battery oscillometry or other suitable battery condition algorithms. The preceding measurements may be obtained at a single point in time or as a time series of historical values. The preceding values may be measured to determine a rate of change in the values. For example, a decrease in charging rate or an increase in discharging rate may be indicative of an aging or failing battery.

In many examples, the recycling application 211 may recharge the rechargeable battery 201 before determining the battery condition. The recycling application 211 may observe and/or control the recharging system 210 to add charge to the rechargeable battery 201. For example, charge may be added to the rechargeable battery 201 in an amount corresponding to a percentage of a present charge capacity of in a range from about 1% to about 75%. The recycling application 211 may also control the recharging system 210 to add charge to the rechargeable battery up to a charge level corresponding to a percentage of a present charge capacity in a range from about 25% to about or 100%.

In various examples, the recycling application 211 may be implemented in one or more different configurations. For example, the recycling application 211 may be a software application executed locally on the networkable device 202. The recycling application 211 may be executed on an embedded battery controller in the networkable device or on a battery management controller of the rechargeable battery. The recycling application 211 may be implemented on a charging controller of a battery charger. The recycling application 211 may be a tethered application running remotely on a computing device networked to the networkable device 202 or a network application running on a computer networked to the networkable device 202. The recycling application 211 may also be network software application executed at least in part on the networkable device 202.

In some examples, the data output interface of the networkable device 202 may include a graphical, textual or color-coded user interface, such as may be provided by a display or indicator lights. The data output interface may also include a tactile or audible user interface, such as a vibrating or audible alarm. The recycling application 211 may direct the recycling instructions to the data output interface by providing a file configured for printing a label, e.g., for a battery to be recycled. The label may include one or more of an identification code for the rechargeable battery, the battery condition, a shipping address, a postage-paid token, an end-consumer identification code, a discount or rebate code, and/or any portion of the recycling instructions. The file may be printed in human-readable and/or machine-readable formats. The data output interface may be included in the rechargeable battery, a battery charger configured to accept the rechargeable battery, the networkable device configured to be powered by the rechargeable battery, and/or a battery recycling station.

In several examples, the recycling instructions may include instructions which may educate, instruct, motivate, and/or incentivize an end user to pursue various desirable recycling or battery management actions. For example, the recycling instructions may include a recycling reminder or incentive, an incentive or reminder for a recycling software update. The recycling instructions may also include a social network recycling token, for example, to indicate that the user may be a conscientious recycler. The recycling instructions may include a recycler contact, a shipping instruction or address, and/or information on rechargeable battery sorting. For example, the rechargeable battery may be sorted for resale, reuse, refurbishment, battery cell recycling, and/or battery material recycling. The recycling instructions may include information regarding rechargeable battery maintenance, for example, a charging schedule, a recycling schedule, a recycling instruction update based on battery condition, a battery usage recommendation, a battery safety recommendation, and/or the battery condition. The recycling instructions may include incentives, for example, a rechargeable battery discount, recommendation, rebate, and/or a sales offer.

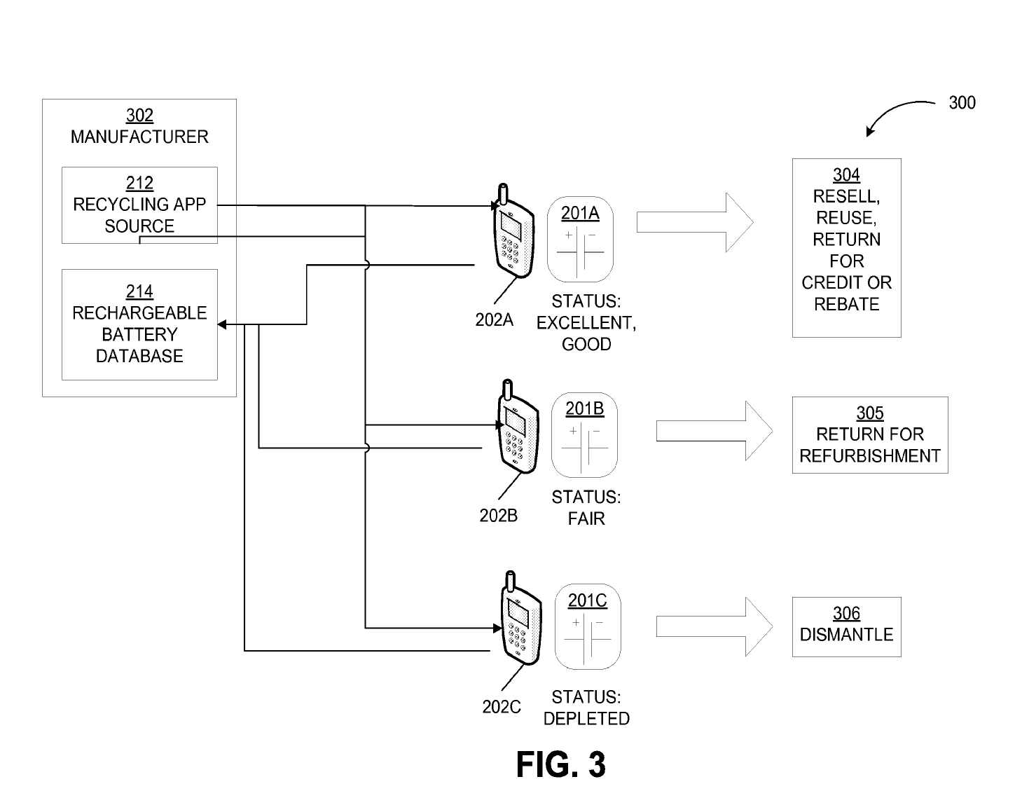

FIG. 3 is a conceptual drawing that represents various examples of a rechargeable battery recycling system 300, arranged in accordance with at least some embodiments described herein. The rechargeable battery recycling system 300 may include networkable devices 202A, 202B, and 202C, for example, smart phones. The networkable devices may communicate over a network connection such as a cell phone network to a central source such as a manufacturer, retailer, or recycler 302. The manufacturer, retailer, or recycler 302 may host the recycling application source 212 and the recycling database 214, for example, using a website. In other examples, the application(s) may also be preinstalled or provided by an application store. The recycling application 211 may run on the networkable devices 202A, 202B, and 202C to determine battery conditions. For example, as depicted in FIG. 2, battery 201A may be found to be in excellent or good condition, and recycling instructions 304 may be provided that suggest reselling, reusing, and/or returning the battery for a credit or rebate. Also as depicted in FIG. 2, battery 201B may be found to be in fair condition, and recycling instructions 305 may be provided that suggest returning the battery for refurbishment. Battery 201C may be found to be in depleted condition, and recycling instructions 306 may be provided that suggest returning the battery for dismantling and materials recycling.

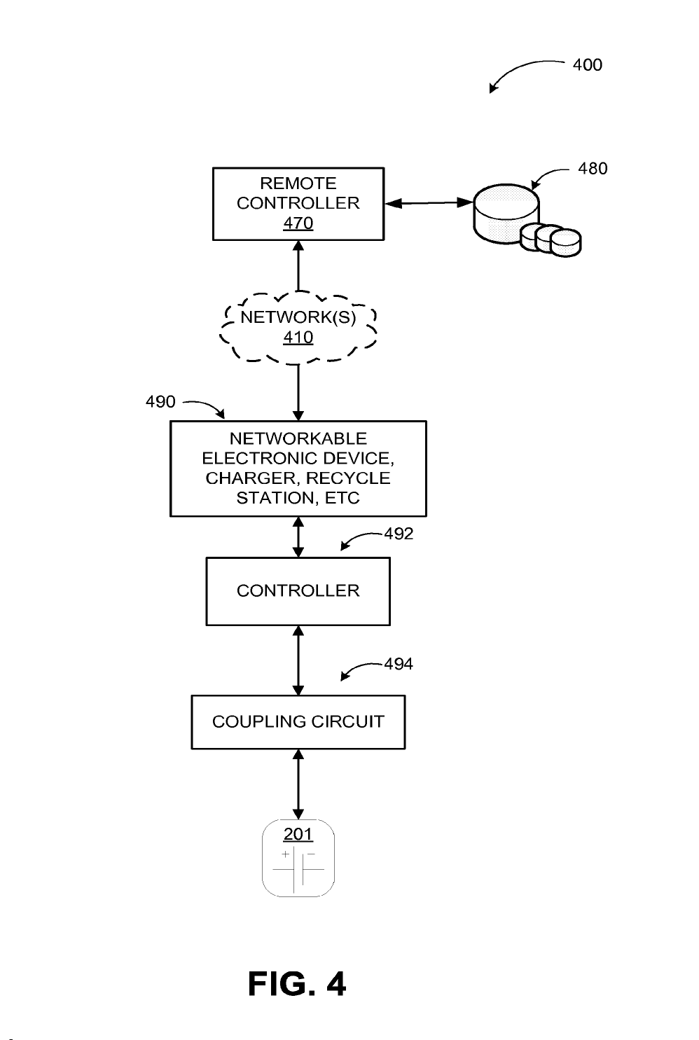

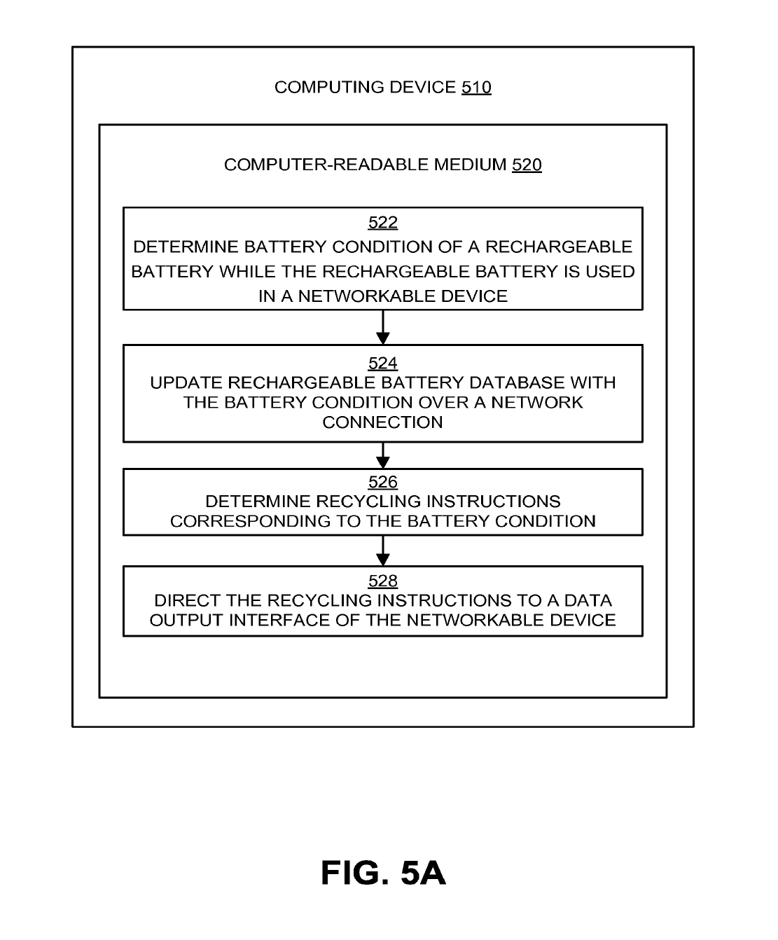

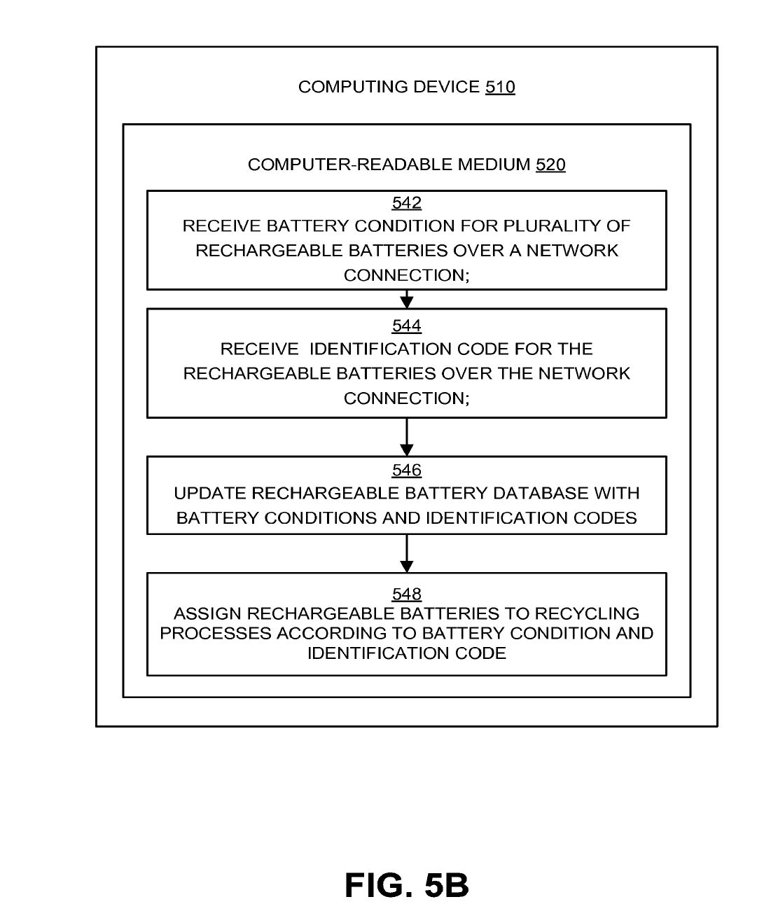

FIG. 4 is a block diagram that represents various examples of automated rechargeable battery recycling systems 400, arranged in accordance with at least some embodiments described herein. The automated rechargeable battery recycling systems 400 may be used for carrying out the described methods of recycling rechargeable batteries using the process steps outlined in FIG. 5A or 5B. As illustrated in FIG. 4, a networkable device 490 may be coupled to the machines that may be used to carry out the process outline described in FIG. 5A or 5B. Networkable device 490 may be operated by human control, by a remote controller 470 via network connection 410, or by machine executed instructions such as might be found in a computer program. Data and programs associated with controlling the different processes of recycling rechargeable batteries, in particular, battery conditions, battery identification codes, recycling applications, recycling instructions, and the like may be stored at and/or received from data stores 480. FIG. 4 also shows that the networkable device 490 may be coupled to a rechargeable battery such as 201 via charging controller 492 and coupling circuit 494.

In several examples, the individual elements of rechargeable battery recycling system 400 may be implemented as any suitable system configured in any suitable fashion for carrying out the operations described herein. For example, networkable device 490 may be any suitable networkable electrical or electronic device, such as a smart phone, a laptop computer, a tablet computer, a power tool, or the like. Likewise, charging controller 492 and coupling circuit 494 may be any suitable controller and circuit, such as an embedded charging controller in a portable electronic device, a battery management controller embedded in a rechargeable battery, a charging controller in a networkable battery charger, or the like. Suitable networks 410 include wired, wireless, and optical networks in any combination, for example, fiber optic networks, Ethernet networks, cellular phone networks, local area networks, and the Internet.

Various example embodiments may also include methods of recycling rechargeable batteries as described herein. These methods may be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. The various human operators need not be collocated with each other, and instead each operated can be located about one or more machines that perform a portion of the operations. In other examples, the human interaction may be automated such as by pre-selected criteria that may be machine automated.

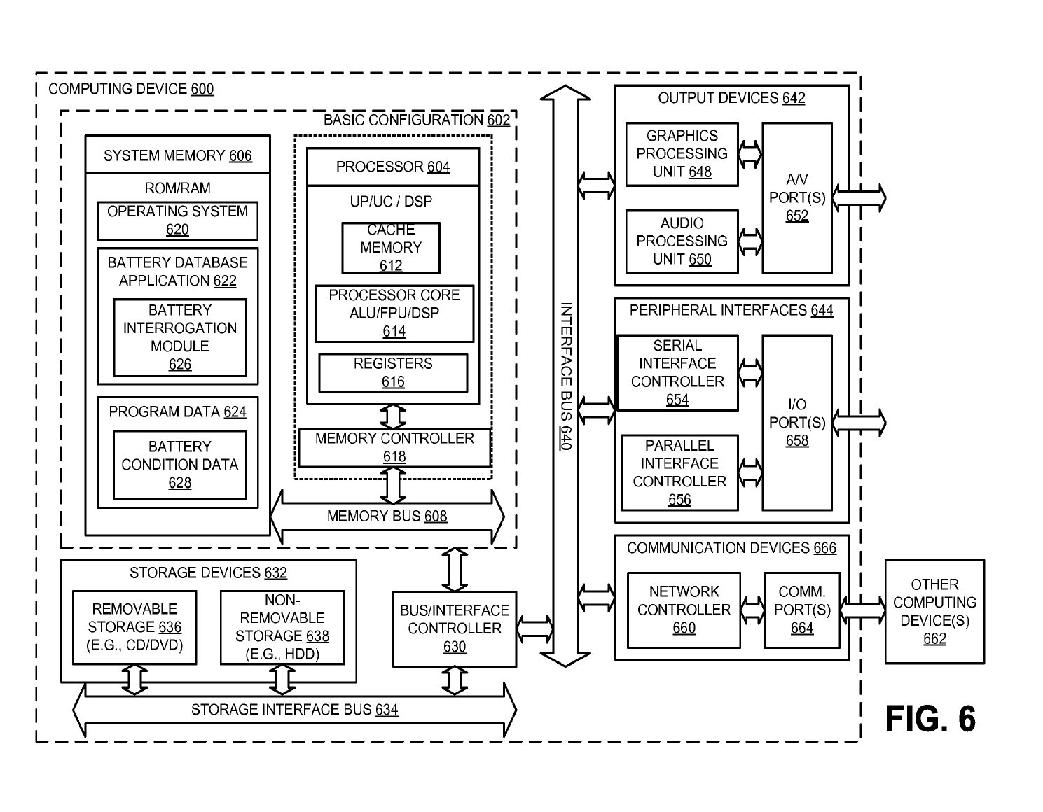

FIG. 5A is a flow diagram showing example blocks that may be used in various example methods of rechargeable battery recycling, arranged in accordance with at least some embodiments described herein. In various examples, a process of rechargeable battery recycling as described herein may include one or more operations, functions or actions as is illustrated by one or more of blocks 522, 524, 526, and/or 528. Various example methods of rechargeable battery recycling as described herein may be controlled by a computing device such as computing device 600 in FIG. 6 or a special purpose controller such as networkable device 490 of FIG. 4. Computing device 510 may be embodied as computing device 600, networkable device 490, or similar devices configured to execute instructions stored in computer-readable medium 520 for controlling the performance of the method.

Some example processes may begin with block 522, “DETERMINE A BATTERY CONDITION OF THE RECHARGEABLE BATTERY WHILE THE BATTERY IS USED IN A NETWORKABLE DEVICE”, where, for example, a networkable device such as 490 or a remote controller such as 470 may be employed to determine a battery condition for a rechargeable battery such as 201.

Block 522 may be followed by block 524, “UPDATE A RECHARGEABLE BATTERY DATABASE WITH THE BATTERY CONDITION OVER A NETWORK CONNECTION”, where, for example, the networkable device such as 490 or a remote controller such as 470 may be employed to deliver the battery condition over network connection 410 to a rechargeable battery database, for example data store 480.

Block 524 may be followed by block 526, “DETERMINE RECYCLING INSTRUCTIONS CORRESPONDING TO THE BATTERY CONDITION”. The recycling instructions may be provided embedded in a local recycling application running on the networkable device 490, or may be provided remotely, for example from data store 480.

Block 526 may be followed by block 528, “DIRECT THE RECYCLING INSTRUCTIONS TO A DATA OUTPUT INTERFACE OF THE NETWORKABLE DEVICE”, where, for example, instructions or incentives for various recycling tasks may be communicated to a user, e.g., on a display coupled to the networkable device 490.

FIG. 5B is a flow diagram showing further example blocks that may be used in various example methods of managing rechargeable battery recycling, arranged in accordance with at least some embodiments described herein. In various examples, a process of managing rechargeable battery recycling as described herein may include one or more operations, functions or actions as is illustrated by one or more of blocks 542, 544, 546, and/or 548. Various example methods of managing rechargeable battery recycling as described herein may be controlled by a computing device such as computing device 600 in FIG. 6 or a special purpose controller such as networkable device 490 of FIG. 4. Computing device 510 may be embodied as computing device 600, networkable device 490, or similar devices configured to execute instructions stored in computer-readable medium 520 for controlling the performance of the method.

Some example processes may begin with block 542, “RECEIVE A BATTERY CONDITION FOR EACH OF A PLURALITY OF RECHARGEABLE BATTERIES OVER A NETWORK CONNECTION”, where, for example, a remote controller such as 470 may be employed to receive a battery condition for a rechargeable battery such as 201 via network connection 410 and networkable device 490.

Block 542 may be followed by block 544, “RECEIVE IDENTIFICATION CODE FOR THE RECHARGEABLE BATTERIES OVER THE NETWORK CONNECTION”, where, for example, a remote controller such as 470 may be employed to receive a battery condition for a rechargeable battery such as 201 via network connection 410 and networkable device 490.

Block 544 may be followed by block 546, “UPDATE A RECHARGEABLE BATTERY DATABASE WITH BATTERY CONDITIONS AND IDENTIFICATION CODES”. The networkable device such as 490 or a remote controller such as 470 may be employed to deliver the battery condition and the battery identification code over network connection 410 to a rechargeable battery database, for example data store 480.

Block 546 may be followed by block 548, “ASSIGN RECHARGEABLE BATTERIES TO RECYCLING PROCESSES ACCORDING TO BATTERY CONDITION AND IDENTIFICATION CODE”, where, for example, batteries in good or excellent condition may be assigned for reuse or resale, batteries in fair condition may be consolidated for industrial use, and depleted batteries may be assigned to materials recycling.

Data regarding the rechargeable batteries, for example, battery condition, battery identification code, recycling instructions or incentives, or the like, may be stored and outputted for use by human or automated processing. For example, battery condition may be provided as quality control feedback to a battery manufacturing process. In another example, used batteries may be sorted according to the respective battery condition and identification code.

The operations included in the process of FIG. 5 described above are for illustration purposes. A process of recycling rechargeable batteries as described herein may be implemented by similar processes with fewer or additional operations. In some examples, the operations may be performed in a different order. In some other examples, various operations may be eliminated. In still other examples, various operations may be divided into additional operations, or combined together into fewer operations. Although illustrated as sequentially ordered operations, in some implementations the various operations may be performed in a different order, or in some cases various operations may be performed at the same or substantially the same time. For example, any other similar process may be implemented with fewer, different, or additional operations so long as such similar processes may facilitate the recycling of rechargeable batteries.

FIG. 6 is a block diagram that represents various general purpose computing devices that may be used to implement the methods for recycling rechargeable batteries, arranged in accordance with at least some embodiments described herein. FIG. 6 illustrates an example general purpose computing device that may be used to control the automated machine 400 of FIG. 4 or similar equipment in carrying out the described methods of recycling rechargeable batteries. In a basic configuration 602, computing device 600 typically may include one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level cache memory 612, a processor core 614, and registers 616. Processor core 614 may include an arithmetic logic unit (ALU), a floating point unit (FPU), a digital signal processing core (DSP Core), or any combination thereof. An example memory controller 618 may also be used with processor 604, or in some implementations memory controller 615 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more rechargeable battery database applications 622, and program data 624. Rechargeable battery database application 622 may include a battery interrogation module 626 that may be arranged to control system 400 of FIG. 4 and any other processes, methods and functions as discussed above. Program data 624 may include, among other data, battery condition data 628 for controlling various aspects of the system 400. This described basic configuration 602 is illustrated in FIG. 6 by those components within the inner dashed line.

Computing device 600 may have additional features or functionality, and additional interfaces to facilitate communications between basic configuration 602 and any devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices may include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 may be examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 666 to basic configuration 602 via bus/interface controller 630. Output devices 642 may include a graphics processing unit 648 and an audio processing unit 650, which may be configured to communicate to various external devices such as a display or speakers via one or more AN ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. A communication device 666 may include a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a physical server, virtual server, a computing cloud, or a hybrid device that include any of the above functions. Computing device 600 may also be implemented as a personal computer including both laptop computer and non-laptop computer configurations. Moreover computing device 600 may be implemented as a networked system or as part of a general purpose or specialized server.

Networks for a networked system including computing device 600 may include any topology of servers, clients, switches, routers, modems, Internet service providers, and any appropriate communication media (e.g., wired or wireless communications). A system according to embodiments may have a static or dynamic network topology. The networks may include a secure network such as an enterprise network (e.g., a LAN, WAN, or WLAN), an unsecure network such as a wireless open network (e.g., IEEE 802.11 wireless networks), or a world-wide network such (e.g., the Internet). The networks may also include a plurality of distinct networks that may be adapted to operate together. Such networks may be configured to provide communication between the nodes described herein. By way of example, and not limitation, these networks may include wireless media such as acoustic, RF, infrared and other wireless media. Furthermore, the networks may be portions of the same network or separate networks.

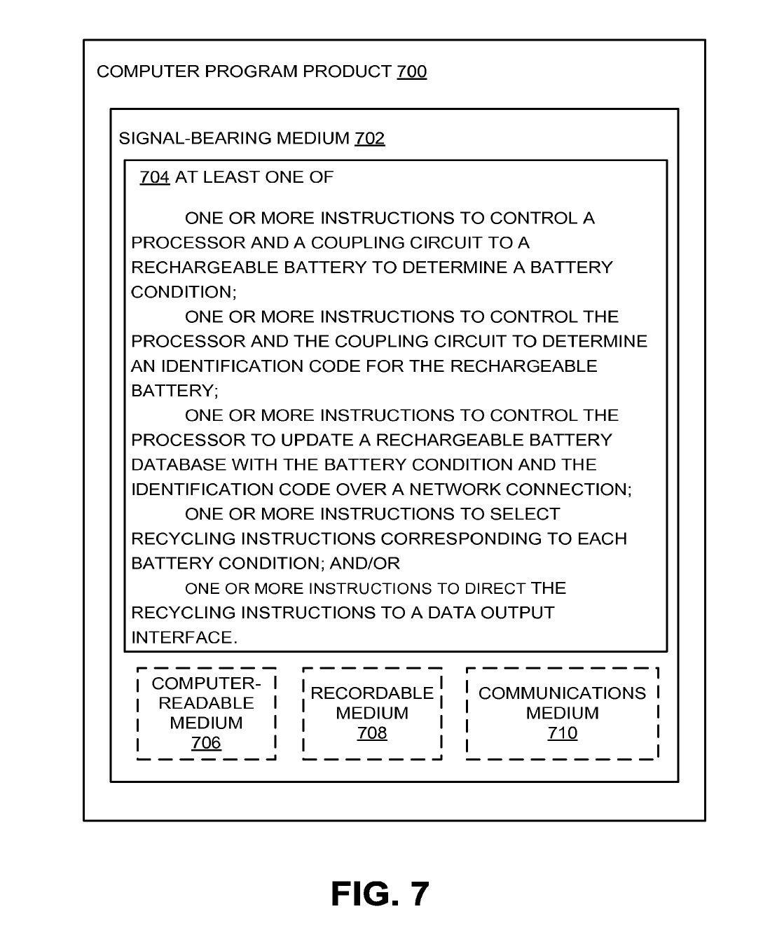

FIG. 7 is a block diagram that illustrates various example computer program products that may be used for rechargeable battery recycling, arranged in accordance with at least some embodiments described herein. In some examples, as shown in FIG. 7, computer program product 700 may include a signal bearing medium 702 that may also include machine readable instructions 704 that, when executed by, for example, a processor, may provide the functionality described above with respect to FIG. 4 through FIG. 6. Some instructions may include, for example, one or more instructions to: “control a processor and a coupling circuit to a rechargeable battery to determine a battery condition”; “control the processor and the coupling circuit to determine an identification code for the rechargeable battery”; “control the processor to update a rechargeable battery database with the battery condition and the identification code over a network connection”; “select recycling instructions corresponding to each battery condition”; and/or “direct the recycling instructions to a data output interface”, according to example embodiments.

In some implementations, signal bearing medium 702 depicted in FIG. 7 may encompass a computer-readable medium 706, such as, but not limited to, a hard disk drive, a Compact Disc (CD), a Digital Versatile Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (e.g., a fiber optic cable, a waveguide, a wired communications link, a wireless communication link, etc.). For example, computer program product 700 may be conveyed to the processor 604 by an RF signal bearing medium 702, where the signal bearing medium 702 may be conveyed by a communications medium 710 (e.g., a wireless communications medium conforming with the IEEE 802.11 standard). While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks may be performed by remote processing devices that may be linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that includes instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing a configuration environment, which may facilitate configuration of software/hardware products and services for a variety of purposes. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

### EXAMPLE 1

### Smart Phone with Rechargeable Battery Recycling Application

A smart phone manufacturer provides a smart phone with a rechargeable battery and a rechargeable battery recycling application. The rechargeable battery recycling application runs in the background on the smart phone when the smart phone is connected to a charger. The rechargeable battery recycling application interfaces with an embedded battery controller in the smart phone to periodically determine battery condition when the smart phone is connected to the charger. The rechargeable battery recycling application updates a rechargeable battery database managed by the manufacturer with the battery condition and a battery identification code. The rechargeable battery recycling application updates the rechargeable battery database through a cell phone network or through a local wireless or wired connection to the internet. The rechargeable battery recycling application also includes a front end with a graphical and textual interface. A smart phone end consumer can activate the graphical and textual interface and learn the condition and history of the battery, and receive battery management and recycling guidance based on the condition of the battery. The end consumer may provide contact information to the rechargeable battery recycling application to receive personalized recycling incentives, such as a social network token indicating that the user is part of a responsible recycling group. The end consumer uses the phone for a period of months or years until the end consumer wishes to recycle the smart phone. The end consumer consults the rechargeable battery recycling application, which reports that the battery is in Fair condition and which qualifies the end consumer for a discount on a new smart phone. The rechargeable battery recycling application provides a printable label including a recycling address for the manufacturer, a postage-paid token, and a machine readable bar code identifying the battery and the battery condition. The end consumer prints the label, attaches it to a mailer, inserts the battery, and mails it to the manufacturer. The manufacturer receives the battery, routes it to industrial consolidation based on the Fair battery condition, and credits the end consumer with the promised discount on a new smart phone.

### EXAMPLE 2

### Car Rental Company with Rechargeable Battery Management Network Application

A car rental company purchases rechargeable battery powered mobile point of sale (POS) devices for rental agents to check in returned rental cars. The car rental company hosts an internal company website which operates a rechargeable battery management network application and a rechargeable battery database. The rechargeable battery management network application communicates over the rental company's wireless network with local copies of a rechargeable battery recycling application on each mobile point of sale device. The local rechargeable battery recycling application runs in the background on the mobile POS device so that the device user normally operates the POS application without needing to continually attend to the rechargeable battery recycling application. The rechargeable battery recycling application interfaces with an embedded battery controller in each POS device to periodically determine battery condition. The rechargeable battery recycling application communicates with the rechargeable battery management network application over the rental company's wireless network to periodically update a rechargeable battery database managed by rental company with each battery condition and battery identification code. The rechargeable battery management network application monitors the individual and collective battery conditions, and provides battery status reports to the information technology department of the car rental company. In conjunction with the rechargeable battery management network application, the information technology department identifies batteries for replacement or recycling based on battery condition. Instructions to return a particular battery for recycling may be delivered to each individual POS device, for example, as a text message or graphical alert delivered to the device at the start of a shift. Each battery has an identification code that permits the information technology department of the car rental company to rapidly sort returned batteries according to battery condition for field redeployment or return to a manufacturer or recycler. The rechargeable battery management network application permits the information technology department of the car rental company to direct a flow of fresh batteries to high usage or high battery damage locations, such as a car rental agency at a busy airport in a hot climate, and to redirect used batteries with remaining life to low usage locations such as a car rental agency at a small airport in a mild climate.

### EXAMPLE 3

### Recycling Center Processing Variety of Rechargeable Batteries

A recycling center accepts a variety of rechargeable batteries from a variety of networkable devices, such as smart phones, cell phones, tablet computers, laptop computers, electric tools, and the like. The recycling center includes a networked machine reader, such as a bar code scanner, to read and identify returned batteries. The machine reader can read a battery code and use a network connection to consult a rechargeable battery database maintained by a consortium of battery manufacturers. Each returned battery is identified as to battery type and battery condition according to the rechargeable battery database maintained by the consortium of battery manufacturers. The returned batteries may be manually or automatically scanned and sorted for different recycling processes according to battery condition. Returned batteries can provide a deposit return or other incentive to the person returning the battery. Additionally or alternatively, returned batteries may provide a recycling incentive back to the registered owner of each recyclable battery where the recyclable battery database includes such information. Battery condition information may also be accessed by the battery manufacturers in the consortium to ascertain battery manufacturing quality, monitor extent of recycling for environmental regulations, or other desired battery research tasks.

In various examples, methods of recycling a rechargeable battery are provided. The example methods may include determining a battery condition of a rechargeable battery while the rechargeable battery may be used in a networkable device. The example methods may also include updating a rechargeable battery database with the battery condition over a network connection. The methods may further include determining recycling instructions corresponding to the battery condition. The methods may additionally include directing the recycling instructions to a data output interface of the networkable device.

In some examples, the method may also include determining an identification code for the rechargeable battery. The method may further include updating the rechargeable battery database with the battery condition and the identification code over the network connection. The network connection may include one or more of: a passive or active electronic interface; a passive or active optical interface; a passive or active radio frequency interface; and/or a combination thereof The networkable device may be a portable networkable electronics device.

In several examples, directing the recycling instructions to the data output interface may include providing a file configured for printing a label that includes one or more of: an identification code for the rechargeable battery; the battery condition; a shipping address; a postage-paid token; an end-consumer identification code; a discount or rebate code; and/or a portion of the recycling instructions. The file may be configured for printing the label to be human-readable, machine-readable, and/or a combination thereof

In many examples, the data output interface may include: a graphical user interface; a textual user interface; a color-coded user interface; a tactile user interface; an audible user interface; and/or a combination thereof The data output interface may be configured as part of: the rechargeable battery; a battery charger configured to accept the rechargeable battery; the networkable device configured to be powered by the rechargeable battery; and/or a battery recycling station.

In various examples, the method may also include determining the battery condition while the rechargeable battery may be in the custody of an end consumer. The method may include determining the battery condition of the rechargeable battery based on one or more of: a charging rate; a discharging rate; a charging cycle; a discharging cycle; a charge depth; a discharge depth; a battery temperature; a time series of historical values thereof; a rate of change in each time series of historical values thereof; and/or a combination thereof. The method may include determining the battery condition by battery oscillometry.

In some examples, the method may include recharging the rechargeable battery before determining the battery condition. The rechargeable battery may be recharged before determining the battery condition by adding charge to the rechargeable battery in an amount corresponding to at least about 10% of a present charge capacity of the rechargeable battery. The rechargeable battery may also be recharged before determining the battery condition by adding charge to the rechargeable battery up to a charge level of at least about 90% of the present charge capacity of the rechargeable battery.

In several examples, the method may include sorting the rechargeable battery for: resale; reuse; refurbishment; battery cell recycling; and/or battery material recycling. The recycling instructions may include one or more of: a recycling reminder; a recycling incentive; a social network recycling token; a recycler contact; a shipping instruction; a rechargeable battery sorting instruction; a rechargeable battery maintenance instruction; a charging schedule; a recycling schedule; a recycling instruction update; an incentive or reminder for a recycling software update; a battery usage recommendation; a battery safety recommendation; a rechargeable battery discount; a rechargeable battery rebate; a rechargeable battery recommendation; a rechargeable battery sales offer; and/or the battery condition.

In numerous examples, the method may include determining the battery condition and the recycling instructions using one or more of: a software application executed on the networkable device that may be configured to be powered by the rechargeable battery; a controller application executed on an embedded battery controller implemented in the networkable device; a management application executed on a battery management controller operatively integrated with the rechargeable battery; a charging application executed on a charging controller included in a battery charger configured to accept the rechargeable battery; a tethered application executed on a computing device that may be configured to be networked to the networkable device; a network application executed at least in part on a computer that may be configured to be networked to the networkable device; and/or the network software application executed at least in part on the networkable device.

In various examples, the networkable device may be: a cell phone, a smart phone, a tablet computer, a laptop computer, a portable media player, a portable Global Positioning System (GPS) device, a portable two-way radio, a cordless tool, a cordless appliance, a battery charger, and/or a combination thereof.

In some examples, methods of managing recycling for a plurality of rechargeable batteries are provided. The example methods may include receiving a battery condition for each of a plurality of rechargeable batteries over a network connection. The example methods may also include receiving a corresponding identification code for each of the plurality of rechargeable batteries over the network connection. The example methods may further include updating a rechargeable battery database with each battery condition and each corresponding identification code. The example methods may additionally include assigning each of the plurality of rechargeable batteries to at least one of a plurality of recycling processes according to each corresponding battery condition and each corresponding identification code.

In several examples, the methods may include physically sorting each of the plurality of rechargeable batteries for recycling among the plurality of recycling processes according to each corresponding battery condition and each corresponding identification code. The recycling processes may include one or more of: reselling rechargeable batteries; reusing rechargeable batteries; refurbishing rechargeable batteries; extracting individual rechargeable battery cells; and/or recycling one or more rechargeable battery materials. The method may include recycling the plurality of rechargeable batteries according to the plurality of recycling processes.

In many examples, the method may include providing a network. The network may be configured as one or more of: a passive or active electronic interface; a passive or active optical interface; a passive or active radio frequency interface; and/or a combination thereof. The network may be configured to communicate with one or more networkable devices, each of the one or more networkable devices being configured to receive at least one of the plurality of rechargeable batteries. The network may also be configured to transmit each battery condition and each corresponding identification code from each of the one or more networkable devices to the battery condition database.

In various examples, the method may include determining each battery condition for each of the plurality of rechargeable batteries while each of the plurality of rechargeable batteries may be installed in the one or more networkable devices. The method may include determining each battery condition for each of the plurality of rechargeable batteries while each of the plurality of rechargeable batteries may be in the custody of an end consumer. The method may also include determining recycling instructions according to the battery condition for at least one rechargeable battery of the plurality of rechargeable batteries. The method may further include directing the recycling instructions over the network to the one or more networkable devices.

In some examples, the method may include employing the network for automatically or manually installing or updating a software application on the one or more networkable devices. The software application may be configured to determine each battery condition for each of the plurality of rechargeable batteries while each of the plurality of rechargeable batteries may be installed in the one or more networkable devices. The one or more networkable devices may include one or more of: a networkable device configured to be powered by one or more of the plurality of rechargeable batteries; an embedded battery controller implemented in the networkable device; a battery management controller operatively coupled to one of the plurality of rechargeable batteries; a charging controller included in a battery charger configured to accept one or more of the plurality of rechargeable batteries; a battery recycling apparatus configured to accept one or more of the plurality of rechargeable batteries; a computing device configured to be operatively coupled to the networkable device; and/or a computer configured to be networked to the networkable device. The one or more networkable devices may include one or more of: a cell phone, a smart phone, a tablet computer, a laptop computer, a portable media player, a portable global positioning system (GPS) device, a portable two-way radio, a cordless tool, a cordless appliance, a battery charger, and/or a combination thereof

In several examples, systems for recycling a rechargeable battery are provided. The example systems may include a coupling circuit configured to be operatively coupled to a rechargeable battery; a network connection; and a controller configured to be operatively coupled via the coupling circuit to the rechargeable battery. The controller may be configured via executable instructions to receive an instruction to determine a battery condition of the rechargeable battery. Executable instructions may be included to determine the battery condition of the rechargeable battery. Executable instructions may also be included to update a rechargeable battery database with the battery condition over the network connection. Executable instructions may further be included to select recycling instructions corresponding to the battery condition. Executable instructions may additionally be included to direct the recycling instructions to a data output interface.

In various examples, the system may further include the rechargeable battery. The controller may be configured as one or more of: a processor of an electronics device that may be configured to be powered by the rechargeable battery; an embedded battery controller implemented in the electronics device; a management controller operatively coupled to the rechargeable battery; a charging controller included in a battery charger configured to accept the rechargeable battery; a battery recycling apparatus configured to accept the rechargeable battery; and/or a computing device configured to be operatively coupled to the electronics device. The electronics device may be: a cell phone, a smart phone, a tablet computer, a laptop computer, a portable media player, a portable Global Positioning Service (GPS) device, a portable two-way radio, a cordless tool, a cordless appliance, and/or a combination thereof

In some examples of the system, the executable instructions may be configured together with the controller as: a software application executed on the electronics device; a controller application executed on the embedded battery controller; a management application executed on the management controller; a charging application executed on the charging controller; a recycler application executed on the battery recycling apparatus; and/or a software application executed on the computing device. The network connection may include one or more of: a passive or active electronic interface; a passive or active optical interface; a passive or active radio frequency interface; and/or a combination thereof

In several examples of the system, the controller may be further configured via the executable instructions to: determine an identification code for the rechargeable battery; and update the rechargeable battery database with the battery condition and the identification code over the network connection. The controller may be further configured via the executable instructions to provide a file configured for printing a label that includes one or more of: an identification code for the rechargeable battery; the battery condition; a shipping address; a postage-paid token; an end-consumer identification code; a discount or rebate code; and/or a portion of the recycling instructions, wherein the file may be configured for printing the label to be human-readable, machine-readable, and/or a combination thereof The data output interface may include at least one of: a display configured to support a graphical user interface or a textual user interface; one or more indicator lights; one or more tactile elements configured to support a tactile user interface; one or more audio transducers configured to support an audible user interface; and/or a combination thereof.

In various examples, the system may be configured to determine the battery condition of the rechargeable battery by acquiring one or more of: a charging rate; a discharging rate; a charging cycle; a discharging cycle; a charge depth; a discharge depth; a battery temperature; a time series of historical values thereof; a rate of change in each time series of historical values thereof; and/or a combination thereof The recycling instructions may include one or more of: a recycling reminder; a recycling incentive; a social network recycling token; a recycler contact; a shipping instruction; a rechargeable battery sorting instruction; a rechargeable battery maintenance instruction; a charging schedule; a recycling schedule; a recycling instruction update; an incentive or reminder for a recycling software update; a battery usage recommendation; a battery safety recommendation; a rechargeable battery discount; a rechargeable battery rebate; a rechargeable battery recommendation; a rechargeable battery sales offer; and/or the battery condition.

In various examples, systems for managing recycling for a plurality of rechargeable batteries are provided. The example systems may include a server and a network. The server may be configured to host a rechargeable battery database. The network may be operatively coupled to the server and may be configured to facilitate communication between the server and a plurality of networkable devices. Each of the plurality of networkable devices may be configured to receive one or more of a plurality of rechargeable batteries. The server may be further configured via computer executable instructions to receive a battery condition for each of the plurality of rechargeable batteries over the network. The server may also include computer executable instructions to receive a corresponding identification code for each of the plurality of rechargeable batteries over the network. The server may further include computer executable instructions to update the rechargeable battery database with each battery condition and each corresponding identification code. The server may additionally include computer executable instructions to assign each of the plurality of rechargeable batteries to at least one of a plurality of recycling processes according to each corresponding battery condition and each corresponding identification code.

In some examples, the system may include a battery sorting apparatus operatively coupled to the server and the network. The battery sorting apparatus may be configured to sort each of the plurality of rechargeable batteries for recycling among the plurality of recycling processes according to each corresponding battery condition and each corresponding identification code. The network may be configured as one or more of: a passive or active electronic interface; a passive or active optical interface; a passive or active radio frequency interface; and/or a combination thereof Each battery condition for each of the plurality of rechargeable batteries may be determined while each of the plurality of rechargeable batteries may be installed in the one or more networkable devices.

In several examples, the server may be further configured to: determine recycling instructions according to the battery condition for at least one rechargeable battery; and direct the recycling instructions over the network to the one or more networkable devices. The server may be further configured to automatically or manually install or update a software application on the one or more networkable devices, wherein the software application may be configured to determine each battery condition for each of the plurality of rechargeable batteries while each of the plurality of rechargeable batteries may be installed in the one or more networkable devices.

In some examples, computer-readable storage media having instructions stored thereon for recycling a rechargeable battery are provided. Instructions may be included to control a processor and a status circuit operatively coupled to a rechargeable battery to determine a battery condition of the rechargeable battery. Instructions may also be included to control the processor and the status circuit to determine an identification code for the rechargeable battery. Instructions may further be included to control the processor to update a rechargeable battery database with the battery condition and the identification code over a network connection. Instructions may additionally be included to select recycling instructions corresponding to the battery condition. Instructions may also be included to direct the recycling instructions to a data output interface.

In several examples, the instructions may further include controlling the processor to provide a file configured for printing a label that includes one or more of: an identification code for the rechargeable battery; the battery condition; a shipping address; a postage-paid token; an end-consumer identification code; a discount or rebate code; and/or a portion of the recycling instructions. The file may be configured for printing the label to be human-readable, machine-readable, and/or a combination thereof The instructions may also include directing the recycling instructions to at least one of: a graphical user interface; a textual user interface; a color-coded user interface; a tactile user interface; an audible user interface; and/or a combination thereof

In various examples, the instructions may include acquiring one or more of: a charging rate; a discharging rate; a charging cycle; a discharging cycle; a charge depth; a discharge depth; a battery temperature; a time series of historical values thereof; a rate of change in each time series of historical values thereof and/or a combination thereof The instructions may also include charging the rechargeable battery before determining the battery condition.

In some examples, the recycling instructions may include one or more of: a recycling reminder; a recycling incentive; a sorting instruction; a social network recycling token; a recycler contact; a shipping instruction; a rechargeable battery sorting instruction; a rechargeable battery maintenance instruction; a charging schedule; a recycling schedule; a recycling instruction update; an incentive or reminder for a recycling software update; a battery usage recommendation; a battery safety recommendation; a rechargeable battery discount; a rechargeable battery rebate; a rechargeable battery recommendation; a rechargeable battery sales offer; and/or the battery condition.

In several examples, the instructions may be executed by one or more of: a software application executed on an electronics device configured to be powered by the rechargeable battery; a controller application executed on an embedded battery controller implemented in the electronics device; a management application executed on a management controller operatively coupled to the rechargeable battery; a charging application executed on a charging controller included in a battery charger configured to accept the rechargeable battery; a recycler application executed on a battery recycling apparatus configured to accept the rechargeable battery; a software application executed on a computing device configured to be operatively coupled to the electronics device; a network software application executed at least in part on a computer configured to be networked to the electronics device; and/or the network software application executed at least in part on the electronics device. The instructions may also be automatically or manually installed or updated over the network connection.

The terms “a” and “an” as used herein mean “one or more” unless the singular is expressly specified. For example, reference to “a base” may include a mixture of two or more bases, as well as a single base.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to, plus or minus 10% of the particular term.

As used herein, “substantially” will be understood by persons of ordinary skill in the art and will vary to some extent depending upon the context in which it is used. If there are uses of the term which are not clear to persons of ordinary skill in the art, given the context in which it is used, “about” will mean up to, plus or minus 10% of the particular term. For example, values which are “substantially equal” may be the same within up to plus or minus 10% of the value.

As used herein, the terms “optional” and “optionally” mean that the subsequently described circumstance may or may not occur, so that the description includes instances where the circumstance occurs and instances where it does not.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical system may be implemented utilizing any suitable commercially available components, such as those typically found in data computing/communication and/or network computing/communication systems. The herein described subject matter sometimes illustrates different components contained within, or coupled together with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g.,” a system having at least one of A, B, and C″ would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

The various aspects and embodiments disclosed herein are for purposes of illustration and are not intended to be limiting, with the true scope and spirit being indicated by the following claims.

1. A method of recycling a rechargeable battery, the method comprising:
determining a battery condition of a rechargeable battery while the rechargeable battery is used in a networkable device, wherein the rechargeable battery is recharged by:
adding charge to the rechargeable battery in an amount corresponding to at least about 10% of a present charge capacity of the rechargeable battery; or
adding charge to the rechargeable battery up to a charge level of at least about 90% of the present charge capacity of the rechargeable battery;
updating a rechargeable battery database with the battery condition over a network connection;
determining recycling instructions corresponding to the battery condition; and
directing the recycling instructions to a data output interface of the networkable device.

2. (canceled)

3. The method of claim 2, wherein the network connection includes one or more of: a passive or active electronic interface, a passive or active optical interface, a passive or active radio frequency interface, or a combination thereof.

4. The method of claim 1, wherein the networkable device is a portable networkable electronics device.

5. (canceled)

6. (canceled)

7. The method of claim 1, wherein the data output interface includes: a graphical user interface, a textual user interface, a color-coded user interface, a tactile user interface, an audible user interface, or a combination thereof.

8. The method of claim 7, wherein the data output interface is configured as part of: the rechargeable battery, a battery charger configured to accept the rechargeable battery, the networkable device configured to be powered by the rechargeable battery, or a battery recycling station.

9. The method of claim 1, further comprising determining the battery condition while the rechargeable battery is in custody of an end consumer.

10. The method of claim 1, further comprising determining the battery condition of the rechargeable battery based on one or more of: a charging rate, a discharging rate, a charging cycle, a discharging cycle, a charge depth, a discharge depth, a battery temperature, a time series of historical values thereof, a rate of change in each time series of historical values thereof, or a combination thereof.

11. The method of claim 10, further comprising determining the battery condition by battery oscillometry.

12. The method of claim 1, further comprising recharging the rechargeable battery before determining the battery condition.

13. (canceled)

14. The method of claim 1, further comprising sorting the rechargeable battery for: resale, reuse, refurbishment, battery cell recycling, or battery material recycling.

15. (canceled)

16. The method of claim 1, further comprising determining the battery condition and the recycling instructions using one or more of: a software application executed on the networkable device that is configured to be powered by the rechargeable battery, a controller application executed on an embedded battery controller implemented in the networkable device, a management application executed on a battery management controller operatively integrated with the rechargeable battery, a charging application executed on a charging controller included in a battery charger configured to accept the rechargeable battery, a tethered application executed on a computing device that is configured to be networked to the networkable device, a network application executed at least in part on a computer that is configured to be networked to the networkable device, or the network software application executed at least in part on the networkable device.

17. (canceled)

18. A method of managing recycling for a plurality of rechargeable batteries, the method comprising:
receiving a battery condition for each of a plurality of rechargeable batteries over a network connection;
receiving a corresponding identification code for each of the plurality of rechargeable batteries over the network connection;
updating a rechargeable battery database with each battery condition and each corresponding identification code; and
assigning each of the plurality of rechargeable batteries to at least one of a plurality of recycling processes according to each corresponding battery condition and each corresponding identification code; and
sorting the plurality of rechargeable batteries according to corresponding battery conditions and corresponding identification codes, wherein the recycling processeses include one or more of: reselling rechargeable batteries, reusing rechargeable batteries, refurbishing rechargeable batteries, extracting individual rechargeable battery cells, and recycling one or more rechargeable battery materials.

19. (canceled)

20. (canceled)

21. The method of claim 18, further comprising recycling the plurality of rechargeable batteries according to the plurality of recycling processes.

22. The method of claim 18, further comprising providing a network, wherein:
the network is configured as one or more of: a passive or active electronic interface; a passive or active optical interface a passive or active radio frequency interface, or a combination thereof;
the network is configured to communicate with one or more networkable devices, each of the one or more networkable devices being configured to receive at least one of the plurality of rechargeable batteries; and
the network is configured to transmit each battery condition and each corresponding identification code from each of the one or more networkable devices to the battery condition database.

23. The method of claim 22, further comprising determining each battery condition for each of the plurality of rechargeable batteries while each of the plurality of rechargeable batteries is installed in the one or more networkable devices.

24. The method of claim 23, further comprising determining each battery condition for each of the plurality of rechargeable batteries while each of the plurality of rechargeable batteries is in custody of an end consumer.

25. (canceled)

26. The method of claim 22, further comprising employing the network for automatically or manually installing or updating a software application on the one or more networkable devices, wherein the software application is configured to determine each battery condition for each of the plurality of rechargeable batteries while each of the plurality of rechargeable batteries is installed in the one or more networkable devices.

27. The method of claim 26, wherein the one or more networkable devices include one or more of: a networkable device configured to be powered by one or more of the plurality of rechargeable batteries, an embedded battery controller implemented in the networkable device a battery management controller operatively coupled to one of the plurality of rechargeable batteries, a charging controller included in a battery charger configured to accept one or more of the plurality of rechargeable batteries, a battery recycling apparatus configured to accept one or more of the plurality of rechargeable batteries, a computing device configured to be operatively coupled to the networkable device, or a computer configured to be networked to the networkable device.

28. A system for recycling a rechargeable battery, the system comprising:
a coupling circuit configured to be operatively coupled to a rechargeable battery;
a network connection; and
a controller configured to be operatively coupled via the coupling circuit to the rechargeable battery, wherein the controller is configured via executable instructions to:
receive an instruction to determine a battery condition of the rechargeable battery;
determine the battery condition of the rechargeable battery;
update a rechargeable battery database with the battery condition over the network connection;
select recycling instructions corresponding to the battery condition;
direct the recycling instructions to a data output interface; and
provide a file configured for printing a label that includes one or more of: an identification code for the rechargeable battery, the battery condition, a shipping address, a postage-paid token, an end-consumer identification code, a discount or rebate code, or a portion of the recycling instructions, wherein the file is configured for printing the label to be human-readable, machine-readable, or a combination thereof.

29. (canceled)

30. The system of claim 28, wherein the controller is configured as one or more of: a processor of an electronics device that is configured to be powered by the rechargeable battery, an embedded battery controller implemented in the electronics device, a management controller operatively coupled to the rechargeable battery, a charging controller included in a battery charger configured to accept the rechargeable battery, a battery recycling apparatus configured to accept the rechargeable battery, or a computing device configured to be operatively coupled to the electronics device.

31. The system of claim 30, wherein the electronics device is: a cell phone, a smart phone, a tablet computer, a laptop computer, a portable media player, a portable Global Positioning Service (GPS) device, a portable two-way radio, a cordless tool, a cordless appliance, or a combination thereof

32. The system of claim 31, wherein the executable instructions are configured together with the controller as: a software application executed on the electronics device, a controller application executed on the embedded battery controller, a management application executed on the management controller, a charging application executed on the charging controller, a recycler application executed on the battery recycling apparatus, or a software application executed on the computing device.

33. The system of claim 28, wherein the network connection includes one or more of: a passive or active electronic interface, a passive or active optical interface, a passive or active radio frequency interface, or a combination thereof.

34. (canceled)

35. (canceled)

36. The system of claim 28, wherein the data output interface includes: a display configured to support a graphical user interface or a textual user interface, one or more indicator lights, one or more tactile elements configured to support a tactile user interface, one or more audio transducers configured to support an audible user interface, or a combination thereof.

37. The system of claim 28, wherein the system is configured to determine the battery condition of the rechargeable battery by acquiring one or more of: a charging rate, a discharging rate, a charging cycle, a discharging cycle, a charge depth, a discharge depth, a battery temperature, a time series of historical values thereof, a rate of change in each time series of historical values thereof, or a combination thereof.

38. The system of claim 28, wherein the recycling instructions include one or more of: a recycling reminder, a recycling incentive, a social network recycling token, a recycler contact, a shipping instruction, a rechargeable battery sorting instruction, a rechargeable battery maintenance instruction, a charging schedule, a recycling schedule, a recycling instruction update, an incentive or reminder for a recycling software update, a battery usage recommendation, a battery safety recommendation, a rechargeable battery discount, a rechargeable battery rebate, a rechargeable battery recommendation, a rechargeable battery sales offer, or the battery condition.

39. A system for managing recycling for a plurality of rechargeable batteries, the system comprising:
a server configured to host a rechargeable battery database;
a network operatively coupled to the server and configured to facilitate communication between the server and a plurality of networkable devices each configured to receive one or more of a plurality of rechargeable batteries, wherein the server is configured via computer executable instructions to:
receive a battery condition for each of the plurality of rechargeable batteries over the network;
receive a corresponding identification code for each of the plurality of rechargeable batteries over the network;
update the rechargeable battery database with each battery condition and each corresponding identification code; and
assign each of the plurality of rechargeable batteries to at least one of a plurality of recycling processes according to each corresponding battery condition and each corresponding identification code; and
a battery sorting apparatus operatively coupled to the server and the network, the battery sorting apparatus configured to sort each of the plurality of rechargeable batteries for recycling according to each corresponding battery condition and each corresponding identification code.

40. (canceled)

41. (canceled)

42. (canceled)

43. The system of claim 39, wherein the server is further configured to:
determine recycling instructions according to the battery condition for at least one rechargeable battery; and
direct the recycling instructions over the network to the one or more networkable devices.

44. The system of claim 39, wherein the server is further configured to automatically or manually install or update a software application on the one or more networkable devices, wherein the software application is configured to determine each battery condition for each of the plurality of rechargeable batteries while each of the plurality of rechargeable batteries is installed in the one or more networkable devices.

45.-52. (canceled)
